(19) United States
(12) Patent Application Publication
(10) Pub. No.: US 2026/0329300 A1
(43) Pub. Date: Oct. 22, 2026

(54) CONTROL SYSTEM

(71) Applicant: TOYOTA JIDOSHA KABUSHIKI KAISHA, Toyota-shi (JP)

(72) Inventors: Satoshi TAKAHASHI, Yokihsma-shi (JP); Kazuhiko Ueda, Tokyo (JP); Takeshi Kanou, Selo-shi (JP); Kento Iwahori, Nagoya-shi (JP)

(73) Assignee: TOYOTA JIDOSHA KABUSHIKI KAISHA, Toyota-shi (JP)

(21) Appl. No.: 19/557,671

(22) Filed: Mar. 5, 2026

(30) Foreign Application Priority Data
Apr. 17, 2025 (JP) 2025-068147

(51) Int. Cl. G05D 1/65; G05D 1/224; G05D 1/249; G05D 1/606; G05D 107/70; G05D 109/10; G05D 111/10

(52) U.S. Cl. CPC G05D 1/65; G05D 1/2246; G05D 1/249; G05D 1/606; G05D 2107/70; G05D 2109/10; G05D 2111/10

(57) ABSTRACT

A control system configured to control a vehicle configured to travel by unattended driving includes: an acquisition unit configured to acquire precondition information related to a friction force between a road surface where the vehicle travels and wheels of the vehicle; and a control unit configured to determine, using the precondition information, an acceleration of the vehicle to travel on the road surface, and cause the vehicle to travel at the determined acceleration.

### CROSS-REFERENCE TO RELATED APPLICATION

This application claims priority to Japanese Patent Application No. 2025-068147 filed on Apr. 17, 2025. The disclosure of the above-identified application, including the specification, drawings, and claims, is incorporated by reference herein in its entirety.

### BACKGROUND

### 1. Technical Field

The present disclosure relates to a control system.

### 2. Description of Related Art

Hitherto, there has been known a technology for causing vehicles to travel by unattended driving in a vehicle manufacturing factory (Japanese Unexamined Patent Application Publication (Translation of PCT Application) No. 2017-538619 (JP 2017-538619 A)).

### SUMMARY

A road surface wet with a liquid such as water may have a smaller friction force between the road surface and wheels than a dry road surface that is not wet. As the friction force between the road surface and the wheels decreases, the wheels are more slippery on the road surface. Therefore, when the deceleration of a vehicle is the same regardless of the presence or absence of wetness and the degree of the wetness, the braking distance of the vehicle increases as the degree of the wetness increases. Thus, the vehicle may be unable to stop at a desired position. When the acceleration of the vehicle is the same regardless of the presence or absence of the wetness and the degree of the wetness, the vehicle may be more likely to sway and become unstable in posture as the degree of the wetness increases. This issue may also occur in a case where the friction force between the road surface and the wheels varies due to factors other than the wetness of the road surface, such as differences in material of the road surface or type of the vehicle.

The present disclosure can be implemented in the following forms.

(1) According to one aspect of the present disclosure, a control system is provided. The control system configured to control a vehicle configured to travel by unattended driving includes: an acquisition unit configured to acquire precondition information related to a friction force between a road surface where the vehicle travels and wheels of the vehicle; and a control unit configured to determine, using the precondition information, an acceleration of the vehicle to travel on the road surface, and cause the vehicle to travel at the determined acceleration. According to this aspect, the control system determines the acceleration of the vehicle using the precondition information related to the friction force between the road surface and the wheels. Thus, the acceleration of the vehicle can be made variable depending on the friction force between the road surface and the wheels. In this aspect, when decelerating the vehicle, the negative acceleration that is the deceleration of the vehicle can be determined to be smaller as the friction force between the road surface and the wheels decreases. Therefore, the vehicle can be gradually decelerated even when the wheels are slippery on the road surface due to the small friction force between the road surface and the wheels. Thus, the accuracy of the stop position of the vehicle can be improved. When accelerating the vehicle, the positive acceleration of the vehicle can be determined to be smaller as the friction force between the road surface and the wheels decreases. Therefore, the vehicle can be gradually accelerated even when the wheels are slippery on the road surface due to the small friction force between the road surface and the wheels. Thus, the vehicle can be stabilized in posture.

(2) In the above aspect, the precondition information may include at least one of a map showing the acceleration depending on the friction force for each area in a worksite where the vehicle travels and a database showing the acceleration depending on the friction force for each work step to be performed on the vehicle. When the precondition information includes the map, the acquisition unit may be configured to further acquire vehicle position information indicating a position of the vehicle, and the control unit may be configured to determine the acceleration of the vehicle to travel on the road surface by referring to the map and identifying the acceleration associated with the area including the position of the vehicle that is identified based on the vehicle position information. When the precondition information includes the database, the acquisition unit may be configured to further acquire step information indicating a work step that is being performed on the vehicle, and the control unit may be configured to determine the acceleration of the vehicle to travel on the road surface by referring to the database and identifying the acceleration associated with the work step identified based on the step information. According to this aspect, the control system can easily determine the acceleration of the vehicle based on the known magnitude relationship of the acceleration depending on the friction force between the road surface and the wheels in each area in the worksite or each work step.

(3) In the above aspect, the precondition information may include at least one of information indicating presence or absence of wetness of the road surface and information indicating a degree of the wetness of the road surface. The control unit may be configured to, when the road surface has the wetness, determine the acceleration of the vehicle to travel on the road surface to be smaller than when the road surface does not have the wetness, and determine the acceleration of the vehicle to travel on the road surface to be smaller as the degree of the wetness of the road surface increases. According to this aspect, the control system can vary the acceleration of the vehicle depending on the presence or absence of the wetness of the road surface. According to this aspect, when decelerating the vehicle on the wet road surface, the negative acceleration that is the deceleration of the vehicle can be determined to be smaller than when decelerating the vehicle on the dry road surface that is not wet. Therefore, the vehicle can be gradually decelerated even when the road surface is wet and the wheels are slippery on the road surface. Thus, the accuracy of the stop position of the vehicle can be improved. When accelerating the vehicle on the wet road surface, the positive acceleration of the vehicle can be determined to be smaller than when accelerating the vehicle on the dry road surface. Therefore, the vehicle can be gradually accelerated even when the road surface is wet and the wheels are slippery on the road surface. Thus, the vehicle can be stabilized in posture. According to this aspect, the control system can vary the acceleration of the vehicle depending on the degree of the wetness of the road surface. According to this aspect, when decelerating the vehicle on the wet road surface, the negative acceleration that is the deceleration of the vehicle can be determined to be smaller as the degree of the wetness of the road surface increases. Therefore, the vehicle can be gradually decelerated even when the wheels are slippery on the road surface due to the high degree of the wetness of the road surface. Thus, the accuracy of the stop position of the vehicle can be improved. When accelerating the vehicle on the wet road surface, the positive acceleration of the vehicle can be determined to be smaller as the degree of the wetness of the road surface increases. Therefore, the vehicle can be gradually accelerated even when the wheels are slippery on the road surface due to the high degree of the wetness of the road surface. Thus, the vehicle can be stabilized in posture.

(4) In the above aspect, the precondition information may include information indicating a material of the road surface. The control unit may be configured to determine the acceleration of the vehicle to travel on the road surface depending on the material of the road surface. According to this aspect, the control system can vary the acceleration of the vehicle depending on the material of the road surface. Thus, the accuracy of the stop position of the vehicle can be improved, and the vehicle can be stabilized in posture.

(5) In the above aspect, the precondition information may include information that determines a type of the vehicle. The control unit may be configured to determine the acceleration of the vehicle to travel on the road surface depending on the type of the vehicle. According to this aspect, the control system can vary the acceleration of the vehicle depending on the type of the vehicle. Thus, the accuracy of the stop position of the vehicle can be improved, and the vehicle can be stabilized in posture.

The present disclosure can be implemented in various forms other than the above control system. For example, the present disclosure can be implemented in the form of a vehicle or a server that can implement at least part of the functions of the control system, a method for controlling a vehicle using the control system, a computer program that implements the control method, or a non-transitory recording medium on which the computer program is recorded.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing the configuration of a control system according to a first embodiment;

FIG. 2 is a block diagram showing the configuration of the control system;

FIG. 3 is a flowchart showing a processing procedure of vehicle travel control according to the first embodiment;

FIG. 4 is a flowchart showing a vehicle control method according to the first embodiment;

FIG. 5 is a flowchart showing a vehicle control method according to a second embodiment;

FIG. 6 is an explanatory diagram showing the schematic configuration of a control system according to a third embodiment; and

FIG. 7 is a flowchart showing a processing procedure of vehicle travel control according to the third embodiment.

### DETAILED DESCRIPTION OF EMBODIMENTS

### A. First Embodiment

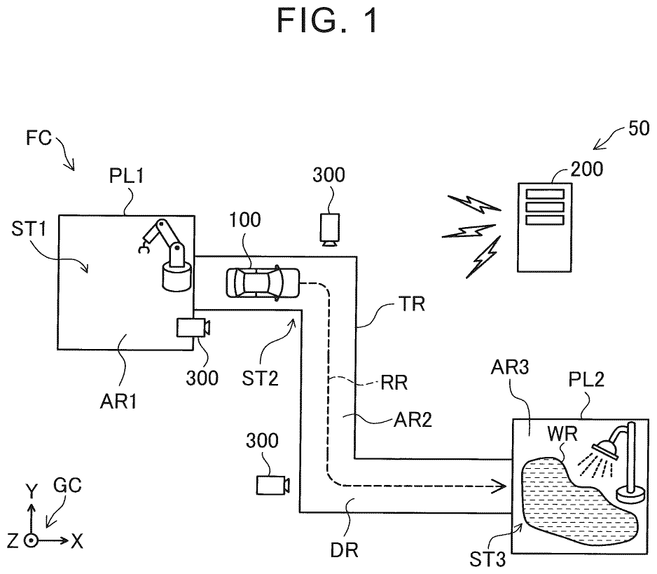

FIG. 1 is a conceptual diagram showing the configuration of a control system 50 according to a first embodiment. The control system 50 includes one or more vehicles 100, a server 200, and one or more external sensors 300.

The vehicle may be a vehicle that travels on wheels or a vehicle that travels on endless tracks, and may be, for example, a passenger car, a truck, a bus, a two-wheeled vehicle, a four-wheeled vehicle, or a construction vehicle. The vehicle includes a battery electric vehicle (BEV), a gasoline-powered vehicle, a hybrid electric vehicle, and a fuel cell electric vehicle.

The vehicle 100 can travel by unattended driving. The term “unattended driving” means driving that is not based on a traveling operation by an occupant. The traveling operation refers to an operation related to at least one of “running,” “turning,” and “stopping” of the vehicle 100. The unattended driving is implemented through automatic or manual remote control using a device located outside the vehicle 100, or through autonomous control by the vehicle 100. The vehicle 100 traveling by unattended driving may have occupants on board who do not perform the traveling operation. Examples of the occupants who do not perform the traveling operation include persons simply sitting in seats of the vehicle 100, and persons performing tasks other than the traveling operation, such as assembly, inspection, and operation on switches, while being on board the vehicle 100. Driving through the traveling operation by an occupant is sometimes referred to as “attended driving.”

The term “remote control” herein includes “full remote control” in which all operations of the vehicle 100 are completely determined from outside the vehicle 100, and “partial remote control” in which part of the operations of the vehicle 100 are determined from outside the vehicle 100. The term “autonomous control” includes “full autonomous control” in which the vehicle 100 autonomously controls its operations without receiving any information from devices outside the vehicle 100, and “partial autonomous control” in which the vehicle 100 autonomously controls its operations using information received from devices outside the vehicle 100.

In the present embodiment, the control system 50 is used in a factory FC where the vehicle 100 is manufactured by performing a plurality of manufacturing steps ST1 to ST3. The reference coordinate system of the factory FC is a global coordinate system GC, and any position in the factory FC can be represented by X, Y, and Z coordinates in the global coordinate system GC. The factory FC includes a first location PL1 and a second location PL2. At each of the first location PL1 and the second location PL2, one or more actual steps such as an assembly step, a painting step, or an inspection step in the manufacturing steps ST1 to ST3 are performed. The first location PL1 and the second location PL2 are connected by a travel path TR along which the vehicle 100 can travel. The vehicle 100 moves from the first location PL1 to the second location PL2 along the travel path TR by unattended driving. On the travel path TR, for example, a transport step in the manufacturing steps ST1 to ST3 is performed to transport the vehicle 100 from the first location PL1 to the second location PL2. The configuration of the factory FC is not limited to the above.

In the factory FC, a plurality of external sensors 300 is installed along the travel path TR. The positions of the external sensors 300 in the factory FC are adjusted in advance. The external sensors 300 are located outside the vehicle 100. The external sensor 300 in the present embodiment is a sensor that captures the vehicle 100 from the outside of the vehicle 100. The external sensor 300 includes a communication device (not shown) and can communicate with other devices such as the server 200 by wired or wireless communication. Specifically, the external sensor 300 is a camera. The camera serving as the external sensor 300 captures an image of the vehicle 100 and outputs the captured image as a detection result.

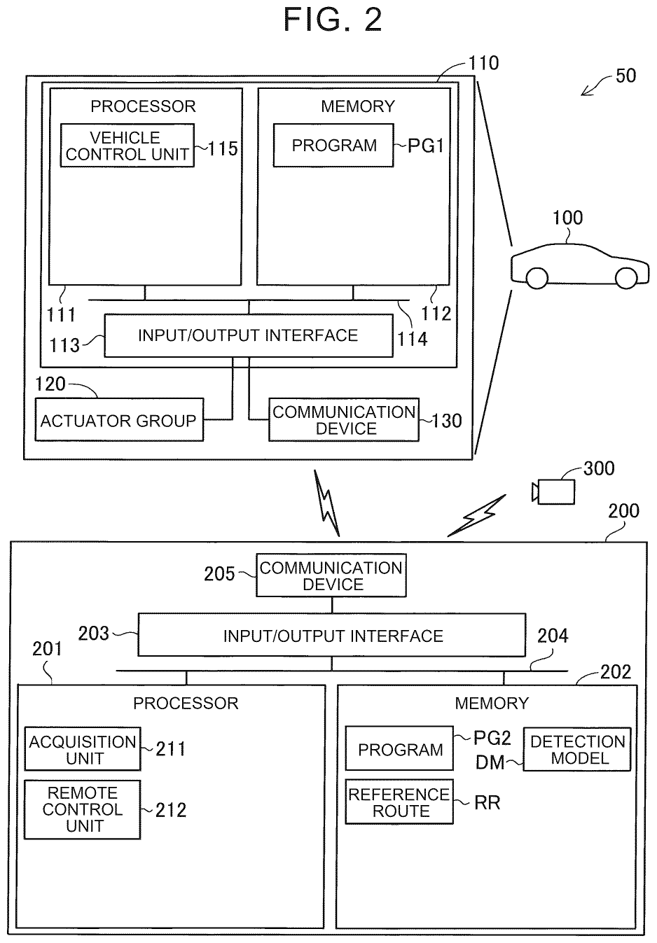

FIG. 2 is a block diagram showing the configuration of the control system 50. The vehicle 100 includes a vehicle control device 110 for controlling each part of the vehicle 100, an actuator group 120 including one or more actuators that are driven under the control of the vehicle control device 110, and a communication device 130 for communicating with external devices such as the server 200 by wireless communication. The actuator group 120 includes an actuator of a drive device for accelerating the vehicle 100, an actuator of a steering device for changing the traveling direction of the vehicle 100, and an actuator of a braking device for decelerating the vehicle 100.

The vehicle control device 110 is a computer including a processor 111, a memory 112, an input/output interface 113, and an internal bus 114. The processor 111, the memory 112, and the input/output interface 113 are connected via the internal bus 114 to bidirectionally communicate with each other. The actuator group 120 and the communication device 130 are connected to the input/output interface 113. The processor 111 implements various functions including a function as a vehicle control unit 115 by executing a program PG1 stored in the memory 112.

The vehicle control unit 115 causes the vehicle 100 to travel by controlling the actuator group 120. The vehicle control unit 115 can cause the vehicle 100 to travel by controlling the actuator group 120 using a traveling control signal received from the server 200. The traveling control signal is a control signal for causing the vehicle 100 to travel. In the present embodiment, the traveling control signal includes an acceleration and a steering angle of the vehicle 100 as parameters. In other embodiments, the traveling control signal may include the speed of the vehicle 100 as a parameter instead of or in addition to the acceleration of the vehicle 100.

The server 200 is a computer including a processor 201, a memory 202, an input/output interface 203, and an internal bus 204. The processor 201, the memory 202, and the input/output interface 203 are connected via the internal bus 204 to bidirectionally communicate with each other. A communication device 205 for communicating with various devices outside the server 200 is connected to the input/output interface 203. The communication device 205 can communicate with the vehicle 100 by wireless communication, and can communicate with each external sensor 300 by wired or wireless communication. The processor 201 implements various functions including functions as an acquisition unit 211 and a remote control unit 212 by executing a program PG2 stored in the memory 202.

The acquisition unit 211 acquires various types of information including precondition information. The precondition information is information related to a friction force between a road surface where the vehicle 100 is traveling and the wheels of the vehicle 100. In the present embodiment, the acquisition unit 211 acquires the precondition information including a map, and vehicle position information indicating the position of the vehicle 100. The map shows the acceleration of the vehicle 100 depending on the friction force between the road surface and the wheels for each of areas AR1 to AR3 in the factory FC.

The remote control unit 212 acquires detection results from the sensors, generates a traveling control signal for controlling the actuator group 120 of the vehicle 100 using the detection results, and transmits the traveling control signal to the vehicle 100, thereby remotely controlling the vehicle 100 to travel. At this time, the remote control unit 212 determines the acceleration of the vehicle 100 using the precondition information, and causes the vehicle 100 to travel at the determined acceleration. In the present embodiment, the remote control unit 212 determines the acceleration of the vehicle 100 by referring to the map and identifying accelerations associated with the areas AR1 to AR3 including the position of the vehicle 100 identified based on the vehicle position information. The remote control unit 212 then generates a traveling control signal for causing the vehicle 100 to travel at the determined acceleration, and transmits the generated traveling control signal to the vehicle 100. Thus, the remote control unit 212 remotely controls the vehicle 100 to travel at the acceleration depending on the friction force between the road surface and the wheels that varies among the areas AR1 to AR3 in the factory FC. In the present disclosure, the term “acceleration” is a concept that includes both a positive acceleration that is an acceleration for accelerating the vehicle 100, and a negative acceleration that is a deceleration for decelerating the vehicle 100.

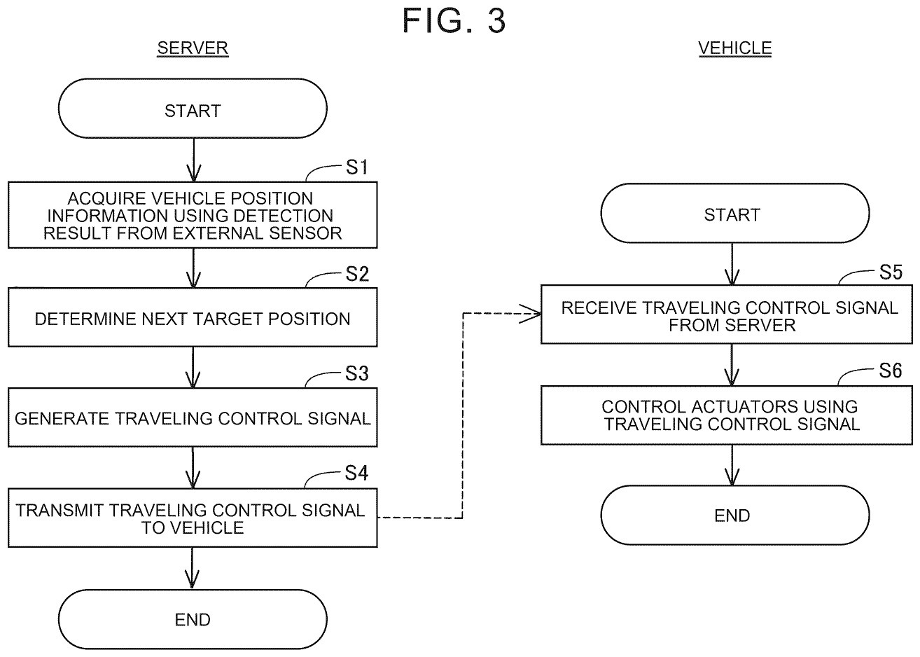

FIG. 3 is a flowchart showing a processing procedure of travel control for the vehicle 100 according to the first embodiment. In the processing procedure of FIG. 3, the processor 201 of the server 200 functions as the remote control unit 212 by executing the program PG2. The processor 111 of the vehicle 100 functions as the vehicle control unit 115 by executing the program PG1.

In step S1, the processor 201 of the server 200 acquires vehicle position information using a detection result output from the external sensor 300. The vehicle position information serves as a basis for generating the traveling control signal. In the present embodiment, the vehicle position information includes the position and orientation of the vehicle 100 in the global coordinate system GC of the factory FC. Specifically, in step S1, the processor 201 acquires the vehicle position information using captured images acquired from the camera that is the external sensor 300.

Specifically, in step S1, the processor 201 detects an external profile of the vehicle 100 from the captured images, calculates the coordinates of the positioning point of the vehicle 100 in a coordinate system of the captured images, that is, a local coordinate system, and converts the calculated coordinates into coordinates in the global coordinate system GC, thereby acquiring the position of the vehicle 100. The external profile of the vehicle 100 included in the captured images can be detected, for example, by inputting the captured images into a detection model DM using artificial intelligence. The detection model DM is prepared, for example, inside or outside the control system 50, and is prestored in the memory 202 of the server 200. Examples of the detection model DM include a trained machine learning model that has been trained to achieve either of semantic segmentation and instance segmentation. For example, a convolutional neural network (hereinafter referred to as “CNN”) trained through supervised learning using a training dataset can be used as the machine learning model. The training dataset includes, for example, a plurality of training images including the vehicle 100, and a label indicating whether each region in the training images is a region indicating the vehicle 100 or a region indicating a field other than the vehicle 100. During training of the CNN, parameters of the CNN are preferably updated to reduce a deviation between the result output from the detection model DM and the label through backpropagation. The processor 201 can acquire the orientation of the vehicle 100 by estimating the orientation, for example, based on the direction of a movement vector of the vehicle 100 calculated from variations in position of feature points of the vehicle 100 between frames of the captured images using an optical flow method.

In step S2, the processor 201 of the server 200 determines a target position to which the vehicle 100 is expected to move next. In the present embodiment, the target position is represented by X, Y, and Z coordinates in the global coordinate system GC. The memory 202 of the server 200 prestores a reference route RR along which the vehicle 100 is expected to travel. The route is represented by a node indicating a departure point, nodes indicating waypoints, a node indicating a destination, and links connecting the nodes. The processor 201 determines the target position to which the vehicle 100 is expected to move next using the vehicle position information and the reference route RR. The processor 201 determines the target position on the reference route RR ahead of the current position of the vehicle 100.

In step S3, the processor 201 of the server 200 generates a traveling control signal for causing the vehicle 100 to travel toward the determined target position. The processor 201 calculates a traveling speed of the vehicle 100 based on transition in the position of the vehicle 100, and compares the calculated traveling speed with a target speed. In general, the processor 201 determines an acceleration such that the vehicle 100 accelerates to the acceleration determined using the precondition information when the traveling speed is lower than the target speed, and determines an acceleration such that the vehicle 100 decelerates to the deceleration determined using the precondition information when the traveling speed is higher than the target speed. When the vehicle 100 is located on the reference route RR, the processor 201 determines a steering angle and an acceleration such that the vehicle 100 does not deviate from the reference route RR. When the vehicle 100 is not located on the reference route RR, that is, when the vehicle 100 deviates from the reference route RR, the processor 201 determines a steering angle and an acceleration such that the vehicle 100 returns to the reference route RR.

In step S4, the processor 201 of the server 200 transmits the generated traveling control signal to the vehicle 100. The processor 201 repeats, at a predetermined cycle, the acquisition of the vehicle position information, the determination of the target position, the generation of the traveling control signal, and the transmission of the traveling control signal.

In step S5, the processor 111 of the vehicle 100 receives the traveling control signal transmitted from the server 200. In step S6, the processor 111 of the vehicle 100 controls the actuator group 120 using the received traveling control signal to cause the vehicle 100 to travel at the acceleration and the steering angle indicated by the traveling control signal. The processor 111 repeats, at a predetermined cycle, the reception of the traveling control signal and the control for the actuator group 120. With the control system 50 according to the present embodiment, the vehicle 100 can be remotely controlled to travel, and the vehicle 100 can be moved without using transport equipment such as a crane or a conveyor.

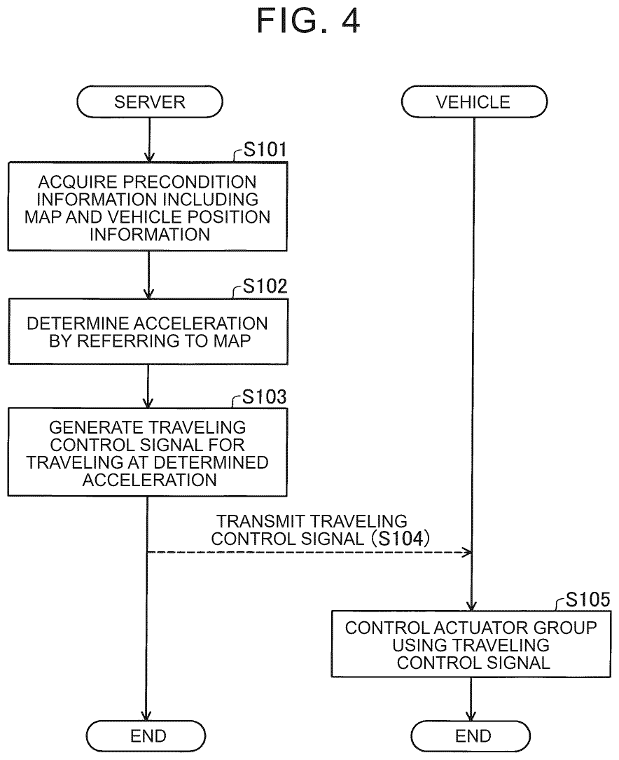

FIG. 4 is a flowchart showing a control method for the vehicle 100 according to the first embodiment. The flow shown in FIG. 4 is repeated at predetermined time intervals, for example, from the time when the vehicle 100 starts traveling by unattended driving. In step S101, the acquisition unit 211 of the server 200 acquires precondition information including a map, and vehicle position information. In step S102, the remote control unit 212 of the server 200 determines the acceleration of the vehicle 100 by referring to the map and identifying accelerations associated with the areas AR1 to AR3 including the position of the vehicle 100 identified based on the vehicle position information. In step S103, the remote control unit 212 generates a traveling control signal for causing the vehicle 100 to travel at the determined acceleration. In step S104, the remote control unit 212 transmits the generated traveling control signal to the vehicle 100. In step S105, the vehicle control unit 115 of the vehicle 100 controls the actuator group 120 using the received traveling control signal to cause the vehicle 100 to travel at the acceleration depending on the friction force between the road surface and the wheels that varies among the areas AR1 to AR3 in the factory FC.

In the first embodiment, the control system 50 is used in the factory FC. In the factory FC, the vehicle 100 is produced using the unattended driving of the vehicle 100. When producing the vehicle 100 using the unattended driving of the vehicle 100, the vehicle 100 travels on a road surface such as a floor inside the building of the factory FC without being placed on transport equipment such as a conveyor. At this time, the manufacturing step ST3 for spraying a liquid onto the vehicle 100 may be performed in the factory FC. The manufacturing step ST3 for spraying the liquid onto the vehicle 100 is, for example, a water leakage inspection step, a cleaning step, or a painting step. The water leakage inspection step is a step of spraying water as the liquid onto the vehicle 100 to inspect whether the water enters the vehicle 100. The cleaning step is a step of cleaning the body of the vehicle 100 using a cleaning agent as the liquid. The painting step is a step of applying a paint as the liquid to the body of the vehicle 100. By performing the manufacturing step ST3 for spraying the liquid onto the vehicle 100, the vehicle 100 may travel on a road surface WR wet with the liquid in the factory FC. The friction coefficient between the road surface and the wheels varies between the wet road surface WR and a dry road surface DR, and therefore the friction force between the road surface and the wheels may vary. The friction coefficient between the road surface and the wheels also varies depending on the degree of wetness of the road surface, and therefore the friction force between the road surface and the wheels may vary. The degree of slipperiness of the wheels on the road surface may vary depending on the difference in friction force between the road surface and the wheels. For example, the wet road surface WR may have a smaller friction force between the road surface and the wheels than the dry road surface DR. Therefore, when traveling on the wet road surface WR, the wheels may be more slippery on the road surface than when traveling on the dry road surface WR. For example, the friction force between the road surface and the wheels decreases as the degree of the wetness increases. Therefore, the wheels may be more slippery on the road surface. Therefore, when the deceleration of the vehicle 100 is the same regardless of the presence or absence of the wetness and the degree of the wetness, the braking distance of the vehicle 100 increases as the degree of the wetness increases. Thus, the vehicle 100 may be unable to stop at a desired position. When the acceleration of the vehicle 100 is the same regardless of the presence or absence of the wetness and the degree of the wetness, the vehicle 100 may be more likely to sway and become unstable in posture as the degree of the wetness increases.

In addition to the above, the vehicle 100 may travel on a painted road surface, a road surface covered with a sheet, or a road surface covered with a metal plate such as a steel plate in the factory FC, and the friction coefficient between the road surface and the wheels may vary depending on the difference in material of the road surface. Since the friction force between the road surface and the wheels varies, the degree of slipperiness of the wheels on the road surface may vary. Further, the normal force of the vehicle 100 against the road surface may vary depending on the weight of the vehicle 100 and the difference in drive system of the vehicle 100, such as 2WD or 4WD. Since the friction force between the road surface and the wheels varies, the degree of slipperiness of the wheels on the road surface may vary. In this way, the friction force between the road surface and the wheels may vary depending on factors other than the wetness of the road surface, such as the differences in material of the road surface or type of the vehicle 100. Thus, the issue similar to the above may occur.

According to the first embodiment, the control system 50 determines the acceleration of the vehicle 100 using the precondition information related to the friction force between the road surface and the wheels. Thus, the acceleration of the vehicle 100 can be made variable depending on the friction force between the road surface and the wheels. In this configuration, when decelerating the vehicle 100, the negative acceleration that is the deceleration of the vehicle 100 can be determined to be smaller as the friction force between the road surface and the wheels decreases. Therefore, the vehicle 100 can be gradually decelerated even when the wheels are slippery on the road surface due to the small friction force between the road surface and the wheels. Thus, the vehicle 100 can be stopped at a desired position. That is, the accuracy of the stop position of the vehicle 100 can be improved. In this configuration, when accelerating the vehicle 100, the positive acceleration of the vehicle 100 can be determined to be smaller as the friction force between the road surface and the wheels decreases. Therefore, the vehicle 100 can be gradually accelerated even when the wheels are slippery on the road surface due to the small friction force between the road surface and the wheels. Thus, the vehicle 100 can be stabilized in posture.

In the first embodiment, the manufacturing steps ST1 to ST3 to be performed at the locations PL1, PL2, TR are known in the factory FC. Therefore, it is possible to make a distinction in advance between the area AR3 where the road surface is wet with the liquid and the areas AR1, AR2 where the road surfaces are not wet with the liquid, and create in advance a map showing the accelerations depending on the road surface conditions in the areas AR1 to AR3. The materials of the road surfaces at the locations PL1, PL2, TR are known in the factory FC. Therefore, it is possible to make a distinction in advance among the areas AR1 to AR3 in the factory FC depending on the differences in materials of the road surfaces, and create in advance a map showing the accelerations depending on the materials of the road surfaces in the areas AR1 to AR3. In this configuration, the acceleration of the vehicle 100 can be easily determined based on the known magnitude relationship of the accelerations depending on the friction force between the road surface and the wheels in the areas AR1 to AR3 in the factory FC.

### B. Second Embodiment

As described above, the manufacturing steps ST1 to ST3 to be performed at the locations PL1, PL2, TR are known in the factory FC. In the present embodiment, the acquisition unit 211 acquires precondition information including a database, and step information. The database shows the acceleration depending on the friction force between the road surface and the wheels for each of the manufacturing steps ST1 to ST3. The step information indicates the manufacturing steps ST1 to ST3 performed on the vehicle 100. The remote control unit 212 determines the acceleration of the vehicle 100 by referring to the database and identifying accelerations associated with the manufacturing steps ST1 to ST3 identified based on the step information. The remote control unit 212 then generates a traveling control signal for causing the vehicle 100 to travel at the determined acceleration, and transmits the generated traveling control signal to the vehicle 100. Thus, the remote control unit 212 remotely controls the vehicle 100 to travel at the acceleration depending on the friction force between the road surface and the wheels that varies among the manufacturing steps ST1 to ST3.

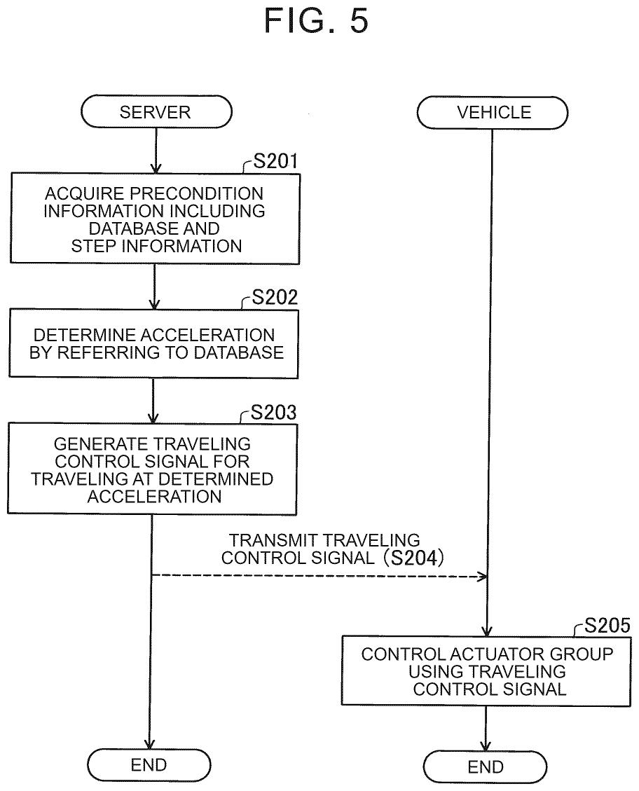

FIG. 5 is a flowchart showing a control method for the vehicle 100 according to the second embodiment. The flow shown in FIG. 5 is repeated at predetermined time intervals, for example, from the time when the vehicle 100 starts traveling by unattended driving. In step S201, the acquisition unit 211 of the server 200 acquires precondition information including a database, and step information. In step S202, the remote control unit 212 of the server 200 determines the acceleration of the vehicle 100 by referring to the database and identifying accelerations associated with the manufacturing steps ST1 to ST3 identified based on the step information. In step S203, the remote control unit 212 generates a traveling control signal for causing the vehicle 100 to travel at the determined acceleration. In step S204, the remote control unit 212 transmits the generated traveling control signal to the vehicle 100. In step S205, the vehicle control unit 115 of the vehicle 100 controls the actuator group 120 using the received traveling control signal to cause the vehicle 100 to travel at the acceleration depending on the friction force between the road surface and the wheels that varies among the manufacturing steps ST1 to ST3.

In the second embodiment, the manufacturing steps ST1 to ST3 to be performed at the locations PL1, PL2, TR are known in the factory FC. Therefore, it is possible to create in advance a database showing the accelerations depending on the materials of the road surfaces and the road surface conditions such as the presence or absence of the wetness and the degree of the wetness at the locations PL1, PL2, TR where the manufacturing steps ST1 to ST3 are performed. In this configuration, the acceleration of the vehicle 100 can be easily determined based on the known magnitude relationship of the accelerations depending on the friction force between the road surface and the wheels in the manufacturing steps ST1 to ST3.

### C. Third Embodiment

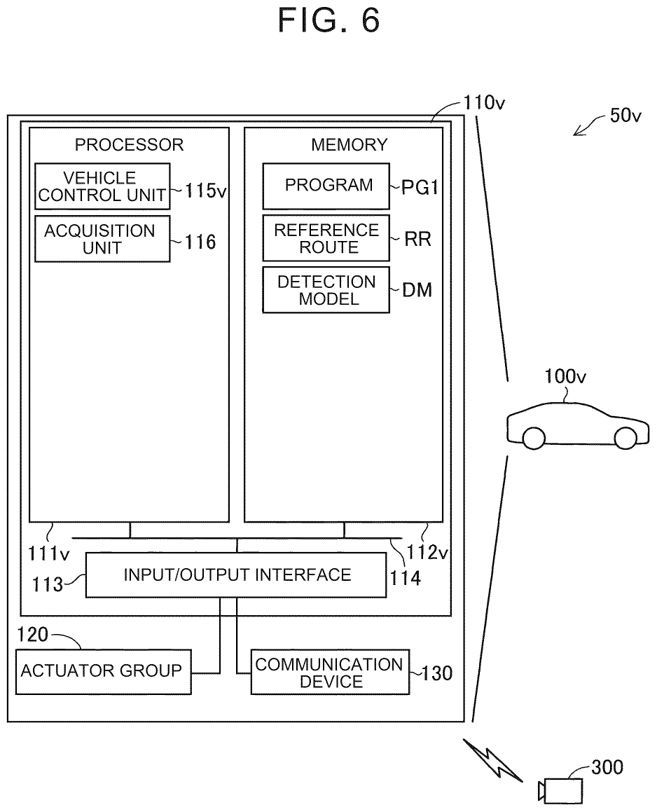

FIG. 6 is an explanatory diagram showing the schematic configuration of a control system 50v according to a third embodiment. The present embodiment differs from the first embodiment in that the control system 50v does not include the server 200. A vehicle 100v in the present embodiment can travel by autonomous control on the vehicle 100v. The other configuration of the third embodiment is the same as that of the first embodiment unless otherwise specified.

In the present embodiment, a processor 111v of a vehicle control device 110v functions as an acquisition unit 116 and a vehicle control unit 115v by executing the program PG1 stored in a memory 112v. The acquisition unit 116 acquires various types of information including precondition information. The vehicle control unit 115v acquires output results from the sensors, generates a traveling control signal using the output results, and outputs the generated traveling control signal to operate the actuator group 120. Thus, the vehicle 100v can travel by autonomous control. In the present embodiment, the memory 112v prestores the detection model DM and the reference route RR in addition to the program PG1. At this time, the vehicle control unit 115v determines the acceleration of the vehicle 100 using the precondition information, and causes the vehicle 100 to travel at the determined acceleration. The vehicle control unit 115v determines the acceleration of the vehicle 100 by referring to a map or a database and identifying accelerations depending on the friction force between the road surface and the wheels. The vehicle control unit 115v then generates a traveling control signal for causing the vehicle 100 to travel at the determined acceleration, and controls the actuator group 120 using the generated traveling control signal. Thus, the vehicle control unit 115v autonomously controls the vehicle 100 to travel at the acceleration depending on the friction force between the road surface and the wheels.

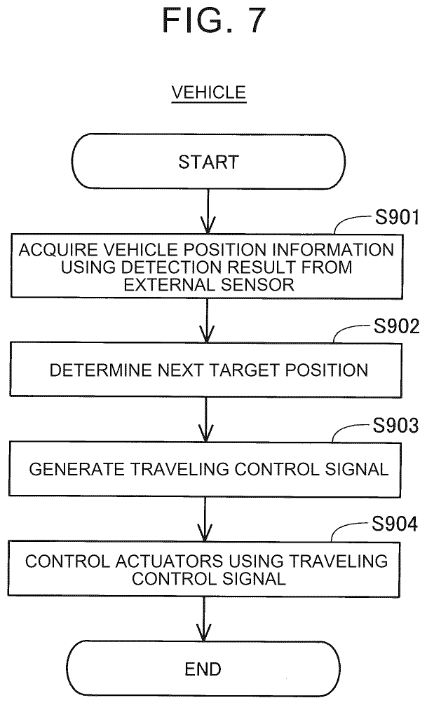

FIG. 7 is a flowchart showing a processing procedure of travel control for the vehicle 100v according to the third embodiment. In the processing procedure of FIG. 7, the processor 111v of the vehicle 100v functions as the vehicle control unit 115v by executing the program PG1.

In step S901, the processor 111v of the vehicle control device 110v acquires vehicle position information using a detection result output from the camera that is the external sensor 300. In step S902, the processor 111v determines a target position to which the vehicle 100v is expected to move next. In step S903, the processor 111v generates a traveling control signal for causing the vehicle 100v to travel toward the determined target position. In step S904, the processor 111v controls the actuator group 120 using the generated traveling control signal to cause the vehicle 100v to travel based on parameters indicated by the traveling control signal. The processor 111v repeats, at a predetermined cycle, the acquisition of the vehicle position information, the determination of the target position, the generation of the traveling control signal, and the control on the actuators. With the control system 50v according to the present embodiment, the vehicle 100v can travel by autonomous control on the vehicle 100v even if the vehicle 100v is not remotely controlled by the server 200.

### D. Other Embodiments

(D1) The acquisition unit 116, 211 may acquire precondition information including information indicating the presence or absence of the wetness of the road surface. In this case, when the road surface is wet, the control unit 115v, 212 may determine the acceleration of the vehicle 100, 100v to be smaller than when the road surface is not wet. In this configuration, the control system 50, 50v can vary the acceleration of the vehicle 100, 100v depending on the presence or absence of the wetness of the road surface. Therefore, when decelerating the vehicle 100, 100v on the wet road surface WR, the negative acceleration that is the deceleration of the vehicle 100, 100v can be determined to be smaller than when decelerating the vehicle 100, 100v on the dry road surface DR. Thus, the vehicle 100, 100v can be gradually decelerated even when the road surface is wet and the wheels are slippery on the road surface. Accordingly, the accuracy of the stop position of the vehicle 100, 100v can be improved. When accelerating the vehicle 100, 100v on the wet road surface WR, the positive acceleration of the vehicle 100, 100v can be determined to be smaller than when accelerating the vehicle 100, 100v on the dry road surface DR. Thus, the vehicle 100, 100v can be gradually accelerated even when the road surface is wet and the wheels are slippery on the road surface. Accordingly, the vehicle 100, 100v can be stabilized in posture.

(D2) The acquisition unit 116, 211 may acquire precondition information including information indicating the degree of the wetness of the road surface. In this case, the control unit 115v, 212 may determine the acceleration of the vehicle 100, 100v to be smaller as the degree of the wetness of the road surface increases. In this configuration, the control system 50, 50v can vary the acceleration of the vehicle 100, 100v depending on the degree of the wetness of the road surface. Therefore, when decelerating the vehicle 100, 100v on the wet road surface WR, the negative acceleration that is the deceleration of the vehicle 100, 100v can be determined to be smaller as the degree of the wetness of the road surface increases. Thus, the vehicle 100, 100v can be gradually decelerated even when the wheels are slippery on the road surface because the degree of the wetness of the road surface is high. Accordingly, the accuracy of the stop position of the vehicle 100, 100v can be improved. When accelerating the vehicle 100, 100v on the wet road surface WR, the positive acceleration of the vehicle 100, 100v can be determined to be smaller as the degree of the wetness of the road surface increases. Thus, the vehicle 100, 100v can be gradually accelerated even when the wheels are slippery on the road surface because the degree of the wetness of the road surface is high. Accordingly, the vehicle 100, 100v can be stabilized in posture.

(D3) The acquisition unit 116, 211 may acquire precondition information including information indicating the material of the road surface. In this case, the control unit 115v, 212 may determine the acceleration of the vehicle 100, 100v depending on the material of the road surface. In this configuration, the control system 50, 50v can vary the acceleration of the vehicle 100, 100v depending on the material of the road surface. Thus, the accuracy of the stop position of the vehicle 100, 100v can be improved, and the vehicle 100, 100v can be stabilized in posture.

(D4) The acquisition unit 116, 211 may acquire precondition information including information that determines the type of the vehicle 100, 100v. In this case, the control unit 115v, 212 may determine the acceleration of the vehicle 100, 100v depending on the type of the vehicle 100, 100v. For example, the wheels may be more slippery on the road surface as the weight of the vehicle 100, 100v decreases. Therefore, the acquisition unit 116, 211 may acquire precondition information including information related to the weight of the vehicle 100, 100v as the information that determines the type of the vehicle 100, 100v. In this case, the control unit 115v, 212 may determine the acceleration of the vehicle 100, 100v to be smaller as the weight of the vehicle 100, 100v decreases. For example, when the drive system of the vehicle 100, 100 v is 2WD, the wheels may be more slippery on the road surface than when the drive system of the vehicle 100, 100 v is 4WD. Therefore, the acquisition unit 116, 211 may acquire precondition information including information related to the drive system of the vehicle 100, 100v as the information that determines the type of the vehicle 100, 100v. In this case, when the drive system of the vehicle 100, 100v is 2WD, the control unit 115 v, 212 may determine the acceleration of the vehicle 100, 100 v to be smaller than when the drive system of the vehicle 100, 100 v is 4WD. In this configuration, the control system 50, 50v can vary the acceleration of the vehicle 100, 100v depending on the type of the vehicle 100, 100v that is determined by the weight, the drive system, etc. of the vehicle 100, 100v. Thus, the accuracy of the stop position of the vehicle 100, 100v can be improved, and the vehicle 100, 100v can be stabilized in posture. The information that determines the type of the vehicle 100, 100v is not limited to the above, and may be an identification symbol or number for identifying the vehicle 100, 100v, or other information such as the number and disposition of the wheels.

(D5) The control system 50, 50v may be used in a place other than the factory FC where the vehicle 100, 100v is manufactured. That is, the control system 50, 50v may control the vehicle 100, 100v after shipment. When the control system 50, 50v is used in a place other than the factory FC, the term “factory” in the present disclosure can be replaced with “worksite” as appropriate, and the term “manufacturing step” in the present disclosure can be replaced with “work step” as appropriate. In this configuration, the control system 50, 50v can determine the acceleration of the vehicle 100, 100v using the precondition information related to the friction force between the road surface and the wheels even in a worksite other than the factory FC, such as a vehicle inspection station. Therefore, the control system 50, 50v can vary the acceleration of the vehicle 100, 100v depending on the friction force between the road surface and the wheels even in the worksite other than the factory FC, such as a vehicle inspection station. Thus, the accuracy of the stop position of the vehicle 100, 100v can be improved and the vehicle 100, 100v can be stabilized in posture even in the worksite other than the factory FC, such as a vehicle inspection station.

(D6) At least part of the functions of the server 200 may be implemented as one function of the vehicle control device 110, 110v, or may be implemented as one function of another device such as the external sensor 300. At least part of the functions of the vehicle control device 110, 110v may be implemented as one function of the server 200, or may be implemented as one function of another device such as the external sensor 300. In this case, the configuration of the control system 50, 50v can be changed as appropriate.

(D7) In each of the above embodiments, the external sensor 300 is not limited to the camera, and may be, for example, a distance measuring device. The distance measuring device is, for example, a light detection and ranging (LiDAR) device. In this case, the detection result output from the external sensor 300 may be three-dimensional point cloud data representing the vehicle 100, 100v. In this case, the server 200 or the vehicle 100, 100v may acquire the vehicle position information by template matching using the three-dimensional point cloud data as the detection result and reference point cloud data prepared in advance.

(D8) In the first and second embodiments, the server 200 performs the process from the acquisition of vehicle position information to the generation of a traveling control signal. Alternatively, the vehicle 100 may perform at least part of the process from the acquisition of vehicle position information to the generation of a traveling control signal. For example, the following configurations (1) to (3) may be adopted.

(1) The server 200 may acquire vehicle position information, determine a target position to which the vehicle 100 is expected to move next, and generate a route from the current position of the vehicle 100 indicated by the acquired vehicle position information to the target position. The server 200 may generate a route to a target position between the current position and the destination, or may generate a route to the destination. The server 200 may transmit the generated route to the vehicle 100. The vehicle 100 may generate a traveling control signal such that the vehicle 100 travels on the route received from the server 200, and control the actuator group 120 using the generated traveling control signal.

(2) The server 200 may acquire vehicle position information and transmit the acquired vehicle position information to the vehicle 100. The vehicle 100 may determine a target position to which the vehicle 100 is expected to move next, generate a route from the current position of the vehicle 100 indicated by the received vehicle position information to the target position, generate a traveling control signal such that the vehicle 100 travels on the generated route, and control the actuator group 120 using the generated traveling control signal.

(3) In the above configurations (1) and (2), an internal sensor may be mounted on the vehicle 100 and a detection result output from the internal sensor may be used in at least one of the generation of a route and the generation of a traveling control signal. The internal sensor is mounted on the vehicle 100. Examples of the internal sensor may include a sensor that detects a motion state of the vehicle 100, a sensor that detects operational states of various components of the vehicle 100, and a sensor that detects the environment around the vehicle 100. Specific examples of the internal sensor may include a camera, a LiDAR device, a millimeter wave radar, an ultrasonic sensor, a global positioning system (GPS) sensor, an acceleration sensor, and a gyro sensor. For example, in the above configuration (1), the server 200 may acquire a detection result from the internal sensor and reflect the detection result from the internal sensor in a route when generating the route. In the above configuration (1), the vehicle 100 may acquire a detection result from the internal sensor and reflect the detection result from the internal sensor in a traveling control signal when generating the traveling control signal. In the above configuration (2), the vehicle 100 may acquire a detection result from the internal sensor and reflect the detection result from the internal sensor in a route when generating the route. In the above configuration (2), the vehicle 100 may acquire a detection result from the internal sensor and reflect the detection result from the internal sensor in a traveling control signal when generating the traveling control signal.

(D9) In the third embodiment, an internal sensor may be mounted on the vehicle 100v and a detection result output from the internal sensor may be used in at least one of the generation of a route and the generation of a traveling control signal. For example, the vehicle 100v may acquire a detection result from the internal sensor and reflect the detection result from the internal sensor in a route when generating the route. The vehicle 100v may acquire a detection result from the internal sensor and reflect the detection result from the internal sensor in a traveling control signal when generating the traveling control signal.

(D10) In the third embodiment, the vehicle 100v acquires the vehicle position information using the detection result from the external sensor 300. An internal sensor may be mounted on the vehicle 100v, and the vehicle 100v may acquire vehicle position information using a detection result from the internal sensor, determine a target position to which the vehicle 100v is expected to move next, generate a route from the current position of the vehicle 100v indicated by the acquired vehicle position information to the target position, generate a traveling control signal such that the vehicle 100v travels on the generated route, and control the actuator group 120 using the generated traveling control signal. In this case, the vehicle 100v can travel without using the detection result from the external sensor 300. The vehicle 100v may acquire a target arrival time and traffic congestion information from the outside of the vehicle 100v, and reflect the target arrival time or the traffic congestion information in at least one of the route and the traveling control signal. All of the functional components of the control system 50v may be provided in the vehicle 100v. That is, the processes implemented by the control system 50v in the present disclosure may be implemented by the vehicle 100v alone.

(D11) In the first and second embodiments, the server 200 automatically generates a traveling control signal to be transmitted to the vehicle 100. The server 200 may generate the traveling control signal to be transmitted to the vehicle 100 in response to an operation by an external operator outside the vehicle 100. For example, the external operator may operate a manipulation device including a display that displays a captured image output from the external sensor 300, a steering wheel, an accelerator pedal, and a brake pedal that are used to remotely operate the vehicle 100, and a communication device that communicates with the server 200 by wired or wireless communication, and the server 200 may generate a traveling control signal in response to an operation performed on the manipulation device.

(D12) In each of the above embodiments, the vehicle 100, 100v only needs to include components that enable movement by unattended driving, and may be, for example, in the form of a platform including the following components. Specifically, the vehicle 100, 100v only needs to include at least the vehicle control device 110, 110v and the actuator group 120 to implement three functions including “running,” “turning,” and “stopping” by unattended driving. In order for the vehicle 100, 100v to acquire information from the outside for unattended driving, the vehicle 100, 100v only needs to include the communication device 130. That is, at least part of interior components such as a driver's seat or a dashboard, at least part of exterior components such as a bumper or a fender, or a body shell may be omitted from the vehicle 100, 100v that is movable by unattended driving. In this case, the remaining components such as the body shell may be mounted on the vehicle 100, 100v before the vehicle 100, 100v is shipped from the factory FC, or may be mounted on the vehicle 100, 100v after the vehicle 100, 100v is shipped from the factory FC with the remaining components such as the body shell unmounted on the vehicle 100, 100v. The components may be mounted on the vehicle 100, 100v from any side such as the upper side, the lower side, the front side, the rear side, the right side, or the left side, and may be mounted from the same side or from different sides. Also in the form of a platform, the position may be determined as with the vehicle 100, 100v according to the first embodiment.

(D13) The vehicle 100, 100v may be manufactured by combining a plurality of modules. A module refers to a unit composed of one or more components grouped according to the structure and function of the vehicle 100, 100v. For example, the platform of the vehicle 100, 100v may be manufactured by combining a front module constituting a front part of the platform, a central module constituting a central part of the platform, and a rear module constituting a rear part of the platform. The number of modules constituting the platform is not limited to three, and may be two or less or four or more. Part of the vehicle 100, 100v other than the platform may be modularized in addition to or instead of the platform. The various modules may include any exterior component such as a bumper or a grille, or any interior component such as a seat or a console. For example, such modules may be manufactured by joining a plurality of components by welding, using a fixture, etc., or may be manufactured by integrally molding at least part of the modules as a single component by casting. The molding method for integrally molding at least part of the modules as a single component is also referred to as gigacasting or megacasting. With the gigacasting, each part of the vehicle 100, 100v that has hitherto been formed by joining a plurality of components can be formed as a single component. For example, the front module, the central module, and the rear module may be manufactured by gigacasting.

(D14) Transport of the vehicle 100, 100v through unattended driving of the vehicle 100, 100v is called “self-propelled transport.” The configuration for implementing the self-propelled transport is called “vehicle remote control autonomous driving transport system.” The method of producing the vehicle 100, 100v using the self-propelled transport is called “self-propelled production.” In the self-propelled production, for example, at least part of the transport of the vehicle 100, 100v in the factory FC that manufactures the vehicle 100, 100v is implemented by the self-propelled transport.

(D15) In each of the above embodiments, part or all of the functions and processes implemented by software may be implemented by hardware. Part or all of the functions and processes implemented by hardware may be implemented by software. Examples of hardware that may be used for implementing the various functions in each of the above embodiments include various types of circuit such as integrated circuits and discrete circuits.

The present disclosure is not limited to the above embodiments, and can be implemented by a variety of configurations without departing from the spirit of the present disclosure. For example, the technical features in each embodiment corresponding to the technical features in each aspect described in “SUMMARY OF THE DISCLOSURE” can be replaced or combined as appropriate in order to solve part or all of the above issues or achieve part or all of the above effects. When the technical features are not described as being essential herein, these features can be omitted as appropriate.

What is claimed is:

1. A control system configured to control a vehicle configured to travel by unattended driving, the control system comprising:
an acquisition unit configured to acquire precondition information related to a friction force between a road surface where the vehicle travels and wheels of the vehicle; and
a control unit configured to determine, using the precondition information, an acceleration of the vehicle to travel on the road surface, and cause the vehicle to travel at the determined acceleration.

2. The control system according to claim 1, wherein:
the precondition information includes at least one of a map showing the acceleration depending on the friction force for each area in a worksite where the vehicle travels and a database showing the acceleration depending on the friction force for each work step to be performed on the vehicle;
when the precondition information includes the map,
the acquisition unit is configured to further acquire vehicle position information indicating a position of the vehicle, and
the control unit is configured to determine the acceleration of the vehicle to travel on the road surface by referring to the map and identifying the acceleration associated with the area including the position of the vehicle that is identified based on the vehicle position information; and
when the precondition information includes the database,
the acquisition unit is configured to further acquire step information indicating a work step that is being performed on the vehicle, and
the control unit is configured to determine the acceleration of the vehicle to travel on the road surface by referring to the database and identifying the acceleration associated with the work step identified based on the step information.

3. The control system according to claim 1, wherein:
the precondition information includes at least one of information indicating presence or absence of wetness of the road surface and information indicating a degree of the wetness of the road surface; and
the control unit is configured to
when the road surface has the wetness, determine the acceleration of the vehicle to travel on the road surface to be smaller than when the road surface does not have the wetness, and
determine the acceleration of the vehicle to travel on the road surface to be smaller as the degree of the wetness of the road surface increases.

4. The control system according to claim 1, wherein:
the precondition information includes information indicating a material of the road surface; and
the control unit is configured to determine the acceleration of the vehicle to travel on the road surface depending on the material of the road surface.

5. The control system according to claim 1, wherein:
the precondition information includes information that determines a type of the vehicle; and
the control unit is configured to determine the acceleration of the vehicle to travel on the road surface depending on the type of the vehicle.
